(19) United States
(12) Patent Application Publication
(10) Pub. No.: US 2013/0082981 A1
(43) Pub. Date: Apr. 4, 2013

(54) OPTICAL TOUCH SYSTEM AND OPTICAL TOUCH DEVICE AND OPTICAL TOUCH METHOD

(71) Applicants: Chih-Wei Chien, Hsin-Chu (TW); Shau-Yu Tsai, Hsin-Chu (TW); Kuang-Tao Sung, Hsin-Chu (TW); Chiung-Han Wang, Hsin-Chu (TW)

(72) Inventors: Chih-Wei Chien, Hsin-Chu (TW); Shau-Yu Tsai, Hsin-Chu (TW); Kuang-Tao Sung, Hsin-Chu (TW); Chiung-Han Wang, Hsin-Chu (TW)

(73) Assignee: AU OPTRONICS CORP., HSINCHU (TW)

(21) Appl. No.: 13/349,774

(22) Filed: Jan. 13, 2012

(30) Foreign Application Priority Data
Oct. 4, 2011 (TW) 100135923

(51) Int. Cl. G06F 3/042

(52) U.S. Cl. 345/175

(57) ABSTRACT

An optical touch system includes a display unit, a touch operation unit, and a data processing unit. The display unit is configured for displaying at least a general image frame and displaying a specific pattern frame alternately with the at least a general image frame. The touch operation unit is configured for scanning a part of the specific pattern frame and capturing image data corresponding to the part of the specific pattern frame for transmission. The data processing unit is configured for translating the image data into a coordinate position. Moreover, an optical touch device and an optical touch method also are provided.

### TECHNICAL FIELD

The disclosure relates to touch systems and touch methods, and more particularly to an optical touch system, an optical touch device and a touch method for the optical touch system.

### BACKGROUND

With the development of display technology, display devices with touch function play more and more important roles in the field of human machine interface technology. In present, some display device manufacturers assemble an on-cell touch module on a display device to endow the display device with touch function. However, such assembling method usually results that the whole display device becomes thicker and heavier and thus does not satisfy the trend of slim and light for display device.

Due to touch modules with different technical architectures causing technology bottlenecks in manufacturing process, it is inconvenient for the display device manufacturers to select a proper type of touch modules. Taking a type of touch module with a projective capacitive architecture as an example, the manufacturing yield of the projective capacitive touch module to be employed in the display device having a size more than 10 inches is low all the time, and the price of the touch module with the projective capacitive architecture accordingly keeps high. For another type of touch module with a complementary metal-oxide-semiconductor transistor (CMOS) optical architecture, due to a high precision being required in assembling of the touch module and the display device, it is liable to cause the capacity of the display device assembled with the touch module too low. In addition, for other types of touch modules, their whole performances are usually inferior to the above two types of touch modules.

For the display device manufacturers, if they do not want to employ the on-cell touch module, they can use the in-cell touch technology to facilitate the display devices to directly realize the touch function instead. However, the in-cell touch technology usually requires changing the manufacturing process or hardware architectures of the display devices so as to realize the touch function for the display devices. Therefore, the manufacturing cost of the display devices would be sharply increased.

### SUMMARY OF DISCLOSURE

Accordingly, an optical touch system in accordance with an embodiment of the disclosure includes a display unit, a touch operation unit, and a data processing unit. The display unit is configured (i.e., structured and arranged) to display at least a general image frame and display a specific pattern frame alternately with the at least a general image frame. The touch operation unit is configured to scan a part of the specific pattern frame and capture image data corresponding to the scanned part of the specific pattern frame. The data processing unit is configured to receive the image data captured by the touch operation unit and translate the image data into a coordinate position.

An optical touch device in accordance with another embodiment of the disclosure includes a display unit configured to display at least a general image frame and display a specific pattern frame alternately with the at least a general image frame. Moreover, the specific pattern frame includes multiple patterns and serves as a basis of positioning a cursor.

An optical touch method in accordance with still another embodiment of the disclosure includes steps of: displaying at least a general image frame; displaying a specific pattern frame alternately with the at least a general image frame; scanning a part of the specific pattern frame, simultaneously with displaying the specific pattern frame, to obtain image data corresponding to the scanned part of the specific pattern frame; and translating the image data into a coordinate position.

### BRIEF DESCRIPTION OF THE DRAWINGS

The above embodiments of the disclosure will become more readily apparent to those ordinarily skilled in the art after reviewing the following detailed description and accompanying drawings.

FIG. 1A is a schematic system block diagram of an optical touch system according to an exemplary embodiment of the disclosure.

FIG. 1B is a schematic system block diagram of an optical touch system according to another exemplary embodiment of the disclosure.

FIG. 2 is a schematic diagram of general image frames and a specific pattern frame being alternately displayed according to an exemplary embodiment of the disclosure.

FIG. 3 is a schematic view of a specific pattern frame according to an exemplary embodiment of the disclosure, the specific pattern frame including a plurality of patterns.

FIG. 3A is a schematic diagram of visible light and invisible light being alternately emitted for illumination according to a preferred exemplary embodiment of the disclosure.

FIG. 4A is a schematic view of single one pattern being scanned.

FIG. 4B is a schematic view of multiple patterns being partially scanned.

FIG. 5 is a flowchart of an optical touch method according to an exemplary embodiment of the disclosure.

### DETAILED DESCRIPTION OF EMBODIMENTS

The disclosure will now be described more specifically with reference to the following embodiments. It is to be noted that the following descriptions of embodiments are presented herein for purpose of illustration and description only. It is not intended to be exhaustive or to be limited to the precise form disclosed.

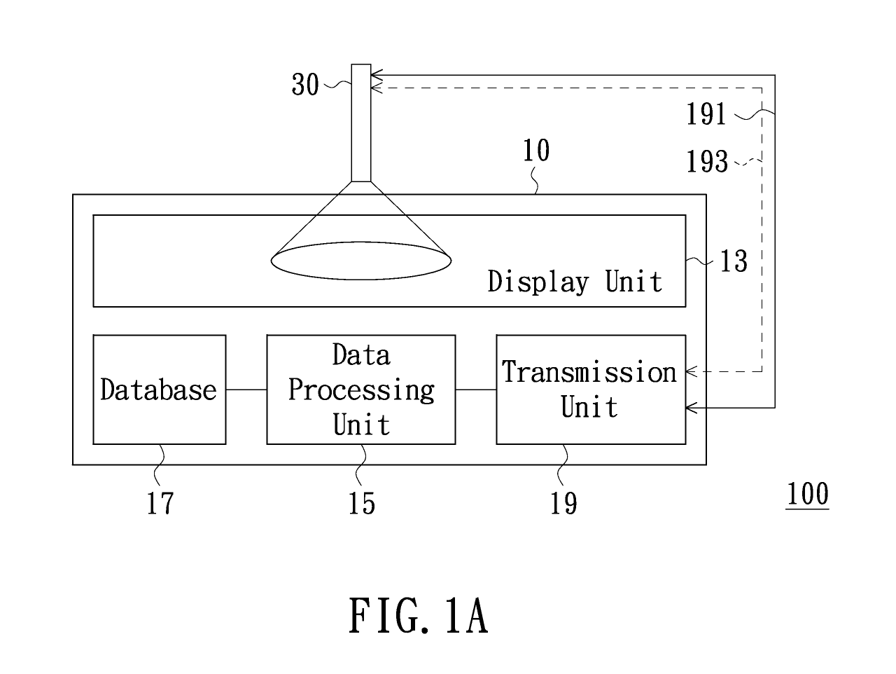

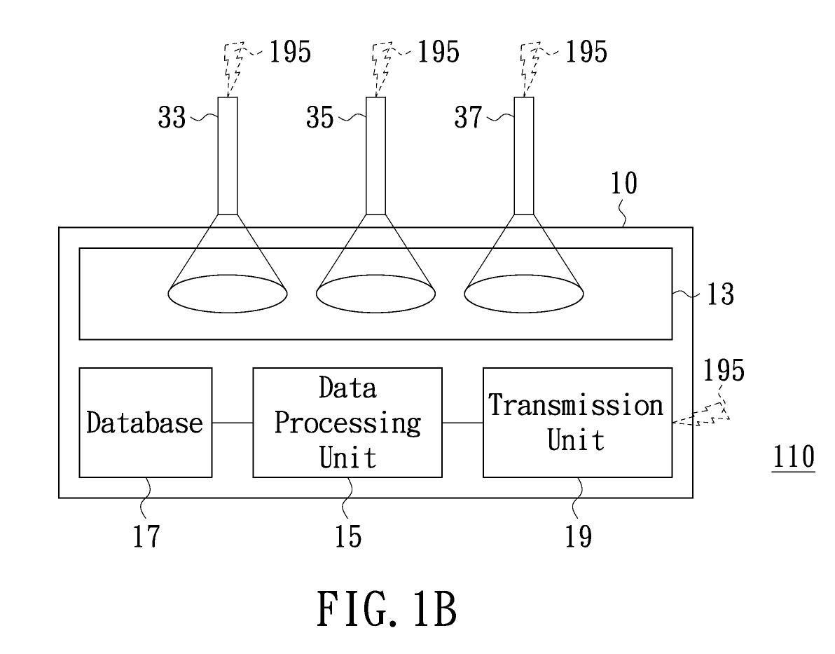

Referring to FIG. 1A, FIG. 1A is a schematic system block diagram of an optical touch system 100 according to an exemplary embodiment of the disclosure. The optical touch system 100 includes an optical touch device 10 and a touch operation unit 30. The optical touch device 10 includes a display unit 13, a data processing unit 15, a database 17, and a transmission unit 19.

The display unit 13 has a display function, and is configured to display general image frames of moving/still images or graphics, or display at least a general image frame according to a received image signal. The display unit 13 further is configured to display a specific pattern frame alternately with the general image frames. The specific pattern frame may be formed by arranging a plurality of patterns with different shapes from one another. The display unit 13 may be, but not limited to, an organic light emitting diode (OLED) display device, a liquid crystal display (LCD) device, a plasma display device, or the like.

The display unit 13 displays the general image frames with a first frame refresh rate and displays the specific pattern frame with a second frame refresh rate alternately with the general image frames, so that the specific pattern frame is displayed among the displays of the general image frames. The second frame refresh rate is preferably lower than the first frame refresh rate. Furthermore, the first frame refresh rate for example is an integer multiple of the second frame refresh rate.

The data processing unit 15 is electrically connected to the display unit 13. The data processing unit 15 can receive image data or signals outputted from the transmission unit 19, or provide signals to the touch operation unit 30 via the transmission unit 19. The data processing unit 15 can perform operations of analysis and/or comparison to the image data. Furthermore, the data processing unit 15 can translate the image data into a coordinate position. In detailed, the data processing unit 15 can translate the image data in real-time according to an interpretation/translation algorithm or perform operations of comparison and analysis to the image data on the assist of the database 17, so as to obtain the coordinate position corresponding to the image data.

Subsequently, the data processing unit 15 informs the display unit 13 to display and position a cursor on the at least a general image frame according to the translated coordinate position. The data processing unit 15 then can obtain information of a clicked area caused by the touch operation unit 30 based on the translated coordinate position, perform a relevant software process according to the obtained information and then feedback a result on the general image frame displayed on the display unit 13, to thereby achieve a touch operation. Briefly speaking, the translated coordinate position can be used as a basis of determining whether to trigger the execution of application program to perform a following touch operation.

The data processing unit 15 may be, for example, a central processing unit (CPU), a micro control unit (MCU), a digital signal processor (DSP), or composed of single chip with functional circuits such as data output/input unit, storage unit, arithmetic logic unit, signal converting unit, timing unit and/or counting unit, and etc.

The database 17 is electrically connected to the data processing unit 15. The database 17 stores the specific pattern frame and a look up table (LUT) associated with coordinate positions corresponding to different parts of the specific pattern frame. The LUT provides data to the data processing unit 15 for performing operations. Furthermore, the LUT can provide the coordinate position corresponding to image data translated by the data processing unit 15. The content of the LUT can be amended, updated or canceled by user. In addition, the database 17 also can store the image data.

The database 17 can be stored in a storage unit. The storage unit may be, for example, a nonvolatile memory, a volatile memory, or a combination of the nonvolatile memory and the volatile memory. The nonvolatile memory may be, but not limited to, a read only memory (ROM), a programmable read only memory (PROM), an electrically alterable read only memory (EAROM), an erasable programmable read only memory (EPROM), an electrically erasable programmable read only memory (EEPROM), flash memory, and the like. The volatile memory may be, but not limited to, a dynamic random access memory (DRAM), an enhanced dynamic random access memory (EDRAM), a static random access memory (SRAM), or the like. In other embodiment, the database 17 can be omitted, and correspondingly the data processing unit 15 translates the image data into the coordinate position in real-time manner.

The transmission unit 19 is electrically connected to the data processing unit 15. The transmission unit 19 can receive the image data outputted from the touch operation unit 30, or provide signals to the touch operation unit 30. The transmission unit 19 can convert data or signals into a transmission format matched with a certain communication protocol. The transmission unit 19 may transmit data, signals and/or power by wired transmission 191 or wireless transmission 193. The wired transmission 191 may be, but not limited to, a universal serial bus (USB), RS-232, IEEE 1394 or the like. The wireless transmission 193 may be, but not limited to, Bluetooth, a wireless network or the like.

The touch operation unit 30 has a function like a touch stylus. The touch operation unit 30 may include an optical imaging device with data and/or image scanning function, a data memory, a data processor, and so on. The optical imaging device may be, for example, a charge coupled device (CCD), a complementary metal oxide semiconductor (CMOS) circuit, a charge injection device (CID), or a combination thereof.

The touch operation unit 30 can scan a part of the specific pattern frame displayed on the display unit 13. Then, the touch operation unit 30 captures and transmits image data corresponding to the scanned part of the specific pattern frame. Preferably, the touch operation unit 30 may be portable and have a chargeable function. In other embodiment, the data processing unit 15 and the database 17 can be disposed in or integrally formed with the touch operation unit 30.

It should be noted that, referring to FIG. 1B, in another exemplary embodiment, the number of the touch operation unit 30 can be increased to be multiple. The multiple touch operation units can simultaneously capture image data of multiple parts of the specific pattern frame for translation, so as to realize the effect of multi-touch. In addition, the wireless transmission 195 is, but not limited to be, employed for being taken as an example in FIG. 1B. The optical touch system 110 in FIG. 1B includes the optical touch device 10, a first touch operation unit 33, a second touch operation unit 35, and a third touch operation unit 37.

The first, second and third touch operation units 33, 35, 37 respectively scan different parts of the specific pattern frame displayed on the display unit 13, capture image data corresponding to the respective scanned parts of the specific pattern frame and transmit the respective captured image data to the data processing unit 15 via the wireless transmission 195. Moreover, the first, second and third touch operation units 33, 35, 37 may transmit the respective image data to the data processing unit 15 by serial transmission manner or parallel transmission manner, and use respective predefined data encapsulating formats to allow the data processing unit 15 to distinguish and identify the image data captured by the respective first, second and third touch operation units 33, 35, 37.

The data processing unit 15 then performs operations such as analyzing and/or comparing the image data to obtain coordinate positions. The data processing unit 15 will informs the display unit 13 to display and position a cursor at three positions on at least a general image frame displayed on the display unit 13 according to the coordinate positions. The data processing unit 15 can obtain information of clicked areas respectively caused by the first, second and third touch operation units 33, 35, 37 based on the coordinate positions, performs relevant software process according to the obtained information and then feedback a result on the general image frame displayed on the display unit 13, to thereby achieve a multi-touch operation.

It should be noted that, a display timing of the specific pattern frame is configured to be synchronized with a scan timing of the touch operation unit 30. For example, when the display unit 13 displays the specific pattern frame, the touch operation unit 30 is set to start for scanning. When the display unit 13 does not display the specific pattern frame, the touch operation unit 30 is set to be stopped scanning.

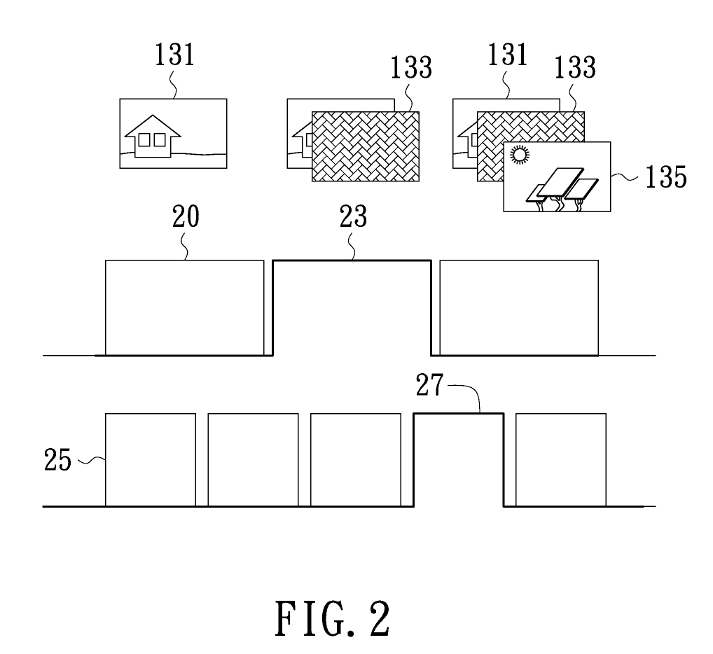

Referring to FIG. 2, FIG. 2 is a schematic diagram of the image frames and the specific pattern frame being alternately displayed. As illustrated in FIG. 2, the specific pattern frame 133 is inserted between a first general image frame 131 and a second general image frame 135. Similarly, the specific pattern frame 133 can be also inserted between the second general image frame 135 and the following general image frame (not shown), and so forth.

The first and second general image frames 131, 135 are displayed on the display unit 13 with a first frame refresh rate 20. The specific pattern frame 133 is displayed on the display unit 13 with a second frame refresh rate 23. It should be noted that, the second frame refresh rate 23 is lower than the first frame refresh rate 20. In addition, the first frame refresh rate 20 is preferably more than 120 Hz for keeping the display quality of 60 Hz.

In another exemplary embodiment, the general image frames are displayed on the display unit 13 with a third frame refresh rate 25, and the specific pattern frame 133 is displayed on the display unit 13 with a fourth frame refresh rate 27 alternately with the display of the general image frames. That is, for example, after three general image frames are continuously displayed, one specific pattern frame 133 is displayed. In addition, the second frame refresh rate 23 or the fourth frame refresh rate 27 influences the sensitivity of touch operation. That is, the higher the second frame refresh rate 23 or the fourth frame refresh rate 27 is, the better the sensitivity of touch operation is.

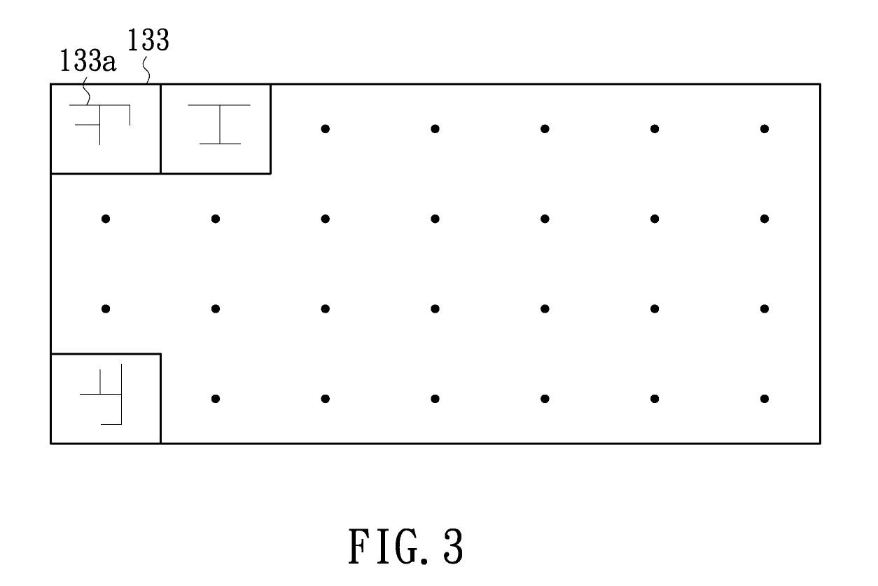

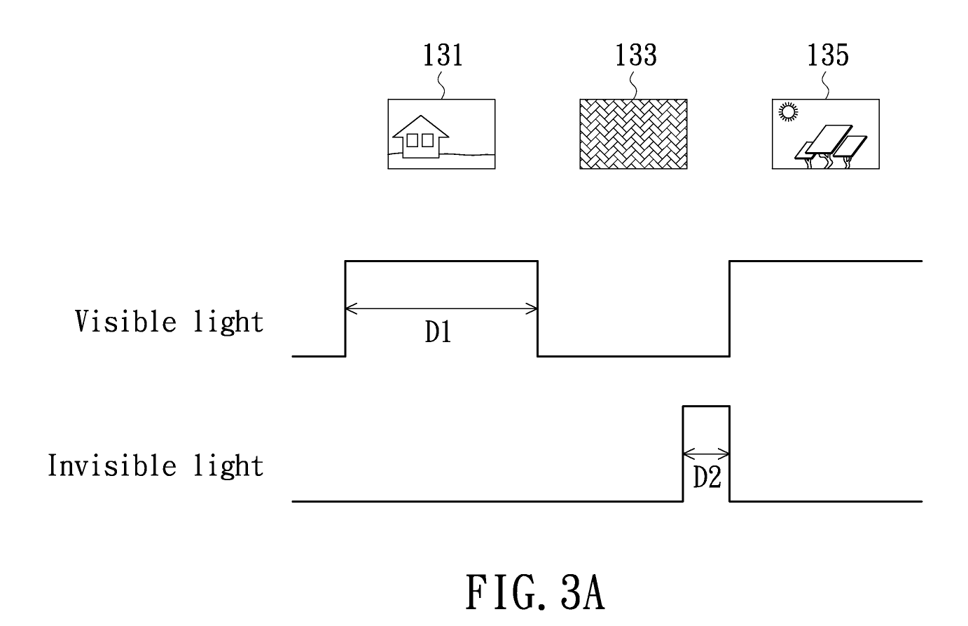

Referring to FIG. 3, FIG. 3 is a schematic view of the specific pattern frame. In FIG. 3, the specific pattern frame 133 is formed by arranging a plurality of patterns 133a. That is, the specific pattern frame 133 is divided into a plurality of parts, each part includes one pattern (or symbol) 133a having a unique shape. The shapes of the plurality of patterns 133a are different from one another. Each pattern 133a is consisted of lines connected together. In other embodiment, the pattern 133a may be consisted of curves, dots or other specific geometric figures.

In an embodiment, in order to achieve both purpose of good image quality and sufficient time for scanning the specific pattern frame, the display unit 13 being a non-emissive display device (e.g., LCD device) will be taken as an example as below. The display unit 13 is configured with a side-type or direct-type backlight source (not shown) which can emit visible light and invisible light in an alternate mode. As illustrated in FIG. 3A, the visible light and invisible light have different light emission duties D1, D2 and each have a refresh rate e.g., higher than 60 Hz. The visible light may be white light, and the invisible light may be near-infrared light, far-infrared light or UV light. For example, the visible light is emitted by turning on visible light, for example white LED or conventional cold-cathode fluorescent lamps (CCFLs), in the backlight source, and the invisible light is emitted by turning on infrared (IR) LED(s) in the backlight source.

Moreover, the alternately displayed general image frame and specific pattern frame are synchronized with the alternately emitted visible light and invisible light respectively. In other words, the visible light is provided for illumination during the display of the general image frames 131, 135, and the invisible light is provided for illumination during the display of the specific pattern frame 133. Correspondingly, the optical imaging device included in any one of the touch operation units 30, 33, 35, 37 is an invisible light imaging device for scanning the patterns in the specific pattern frame 133 displayed by invisible light.

Regarding the arrangement of patterns in the specific pattern frame, for example, if the display unit 13 has a size of 21.5 inches, the length thereof is about 476.64 mm and the width is about 268.11 mm. When single one pattern 133a has a size of 5×5 pixels and an interval between two adjacent patterns 133a is 1.24 mm, the specific pattern frame 133 can be divided into 82944 parts. When single one pattern 133a has a size of 12×12 pixels and the interval between two adjacent patterns 133a is 2.98 mm, the specific pattern frame 133 can be divided into 14400 parts. In addition, when single one pattern 133a has a size of 20×20 pixels and the interval between two adjacent patterns 133a is 4.97 mm, the specific pattern frame 133 can be divided into 5184 parts, and so forth.

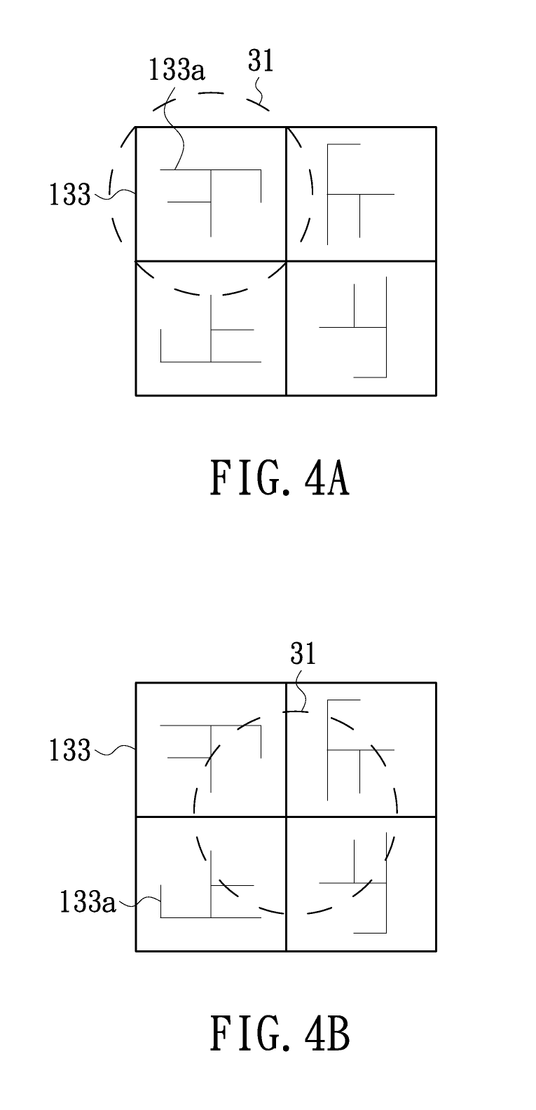

In the following, process of pattern 133a scanning and translating will be described in detail, but it is not to limit the disclosure. Referring to FIG. 4A, FIG. 4A is a schematic view of single one pattern 133a being scanned. In FIG. 4A, the user can perform a touch operation on the display unit 13 via the touch operation unit 30, and the touch operation unit 30 then causes a scanned area 31 on the display unit 13. When the scanned area 31 locates on single one pattern 133a, the touch operation unit 30 captures the image data corresponding to the single pattern 133a and then transmits the image data to the data processing unit 15. Then, the data processing unit 15 analyzes and compares the image data according to the LUT in the database 17, so as to translate the image data into a coordinate position. The coordinate position then is used as a determination basis of whether executing a relevant touch process.

Referring to FIG. 4B, FIG. 4B is a schematic view of multiple patterns 133a being partially scanned. In FIG. 4B, when the scanned area 31 locates among multiple patterns 133a, the touch operation unit 30 captures the image data corresponding to parts of respective patterns 133a and transmits the captured image data to the data processing unit 15. Then, the data processing unit 15 uses an interpolation algorithm to compare and calculate the information of the multiple partial patterns 133a corresponding to the image data. Afterwards, the data processing unit 15 can translate the coordinate position corresponding to the scanned area 31 according to the LUT in the database 17. The coordinate position then is used as a determination basis of whether executing a relevant touch process.

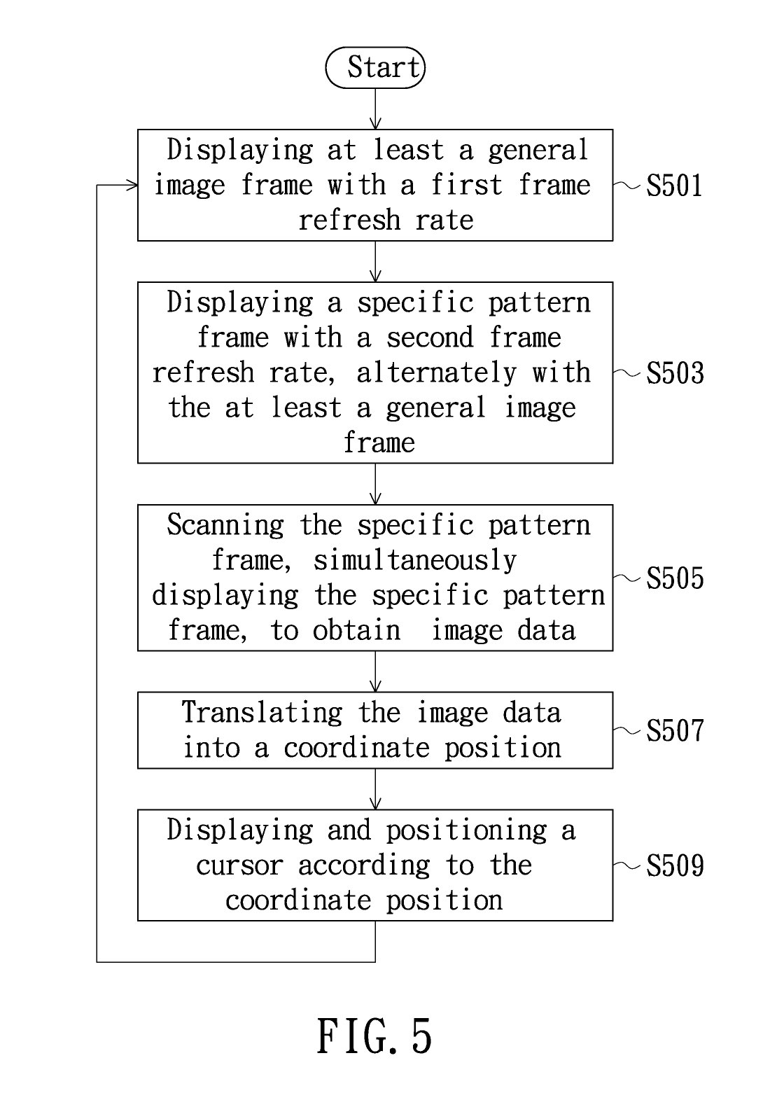

Referring to FIG. 5, FIG. 5 is a flowchart of an optical touch method according to an exemplary embodiment of the disclosure. Firstly, in step S501, the display unit 13 displays at least a general image frame with a first frame refresh rate as an operation image frame for the user to perform a touch operation.

Subsequently, in step S503, the display unit 13 displays a specific pattern frame with a second frame refresh rate alternately with the at least a general image frame. The second frame refresh rate is lower than the first frame refresh rate. Moreover, the first frame refresh rate is an integer multiple of the second frame refresh rate. The specific pattern frame is formed by a plurality of patterns (or symbols) with different shapes from one another arranged in a certain manner (e.g., in matrix manner). In an embodiment, the specific pattern frame is illuminated with invisible light, e.g., near-infrared light, far-infrared light or UV (ultraviolet) light.

In step S505, when the display unit 13 displays the specific pattern frame, the touch operation unit 30 simultaneously scans the specific pattern frame and capture image data corresponding to a scanned part of the specific pattern frame. In detailed, during the touch operation unit 30 simultaneously scans the specific pattern frame, if the scanned area is located among multiple patterns with different shapes, the data processing unit 15 uses an interpolation algorithm to compare and calculate the coordinate position corresponding to the image data. In an exemplary embodiment, the touch operation unit 30 can obtain the image data of the scanned area via a successive capturing method.

In step S507, the data processing unit 15 acquires the image data through the transmission unit 19 and translates the received image data into a coordinate position via searching the look up table. In other embodiment, the number of the touch operation unit 30 can be increased to be multiple (as illustrated in FIG. 1B), so that the multiple touch operation units are configured to simultaneously capture and translate image data corresponding to multiple scanned parts of the specific pattern frame, to thereby realize the effect of multi-touch.

Next, in step S509, the data processing unit 15 informs the display unit 13 to display and position a cursor according to the coordinate position, allowing the user to determine whether the current touch process can normally run. In other embodiment, the data processing unit 15 can obtain information of a clicked area caused by the touch operation unit 30 based on the coordinate position, perform a relevant software process according to the obtained information and then feedback the result on a general image frame displayed on the display unit 13, to thereby achieve a touch operation.

In summary, the optical touch system, the optical touch device, and the touch method of the disclosure insert the specific pattern frame between the displays of general image frames and use the touch operation unit with image sensing function to obtain the coordinate position of the clicked area caused by the user via the touch operation unit and then perform a relevant software process. As a result, the touch function can be achieved.

Because without changing the manufacturing process and hardware architecture of display device, the manufacturing yield and capacity of display device are not affected, and the display device would be given with touch function at low cost. Furthermore, the optical touch system, the optical touch device and the touch method of the disclosure can be used in various types of electronic information processing devices (such as televisions, notebooks, tablet computers, desktop computers, smart phones, or the like) with any sized display device, and thus have high compatibility.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical touch system comprising:
a display unit, configured to display at least a general image frame and display a specific pattern frame alternately with the at least a general image frame;
a touch operation unit, configured to scan a part of the specific pattern frame and capture image data corresponding to the scanned part of the specific pattern frame; and
a data processing unit, configured to receive the image data captured by the touch operation unit and translate the image data into a coordinate position.

2. The optical touch system according to claim 1, further comprising:
a database, configured to store a look up table associated with the specific pattern frame and coordinate positions respectively corresponding to different parts of the specific pattern frame, and further configured to provide the coordinate position corresponding to the image data translated by the data processing unit.

3. The optical touch system according to claim 1, wherein the data processing unit is further configured to inform the display unit to display and position a cursor on the at least a general image frame according to the translated coordinate position.

4. The optical touch system according to claim 1, wherein a display timing of the specific pattern frame is configured to be synchronized with a scan timing of the touch operation unit.

5. The optical touch system according to claim 1, wherein the display unit is configured to display the at least a general image frame with a first frame refresh rate and display the specific pattern frame with a second frame refresh rate alternately with the at least a general image frame.

6. The optical touch system according to claim 5, wherein the second frame refresh rate is lower than the first frame refresh rate.

7. The optical touch system according to claim 5, wherein the first frame refresh rate is an integer multiple of the second frame refresh rate.

8. The optical touch system according to claim 1, wherein the specific pattern frame is formed by a plurality of patterns with different shapes.

9. The optical touch system according to claim 8, wherein when a scanned area by the touch operation unit is located among multiple ones of the patterns with different shapes, the data processing unit is configured to use an interpolation algorithm to translate the image data into the coordinate position.

10. The optical touch system according to claim 1, further comprising:
a transmission unit, electrically connected with the data processing unit and configured to receive the image data captured by the touch operation unit and transmit the image data to the data processing unit.

11. The optical touch system according to claim 10, wherein the touch operation unit is configured to transmit the image data to the transmission unit in a wired manner or a wireless manner.

12. The optical touch system according to claim 1, wherein the display unit is a non-emissive display device and configured with a backlight source, the backlight source is configured to alternately emit visible light and invisible light, and the alternately displayed general image frame and specific pattern frame are synchronized with the alternately emitted visible light and invisible light respectively.

13. The optical touch system according to claim 12, wherein the visible light and the invisible light have different light emission duties and further each have a refresh rate higher than 60 Hz.

14. The optical touch system according to claim 12, wherein the touch operation unit is configured with an invisible light imaging device.

15. The optical touch system according to claim 12, wherein the invisible light is selected from the group consisting of near-infrared light, far-infrared light and UV light.

16. An optical touch device comprising:
a display unit, configured to display at least a general image frame and display a specific pattern frame alternately with the at least a general image frame,
wherein the specific pattern frame comprises specific patterns and serves as a basis of positioning a cursor.

17. The optical touch device according to claim 16, wherein the display unit is configured to display the at least a general image frame with a first frame refresh rate and display the specific pattern frame with a second frame refresh rate.

18. The optical touch device according to claim 17, wherein the second frame refresh rate is lower than the first frame refresh rate.

19. The optical touch device according to claim 17, wherein the first frame refresh rate is an integer multiple of the second frame refresh rate.

20. The optical touch device according to claim 16, wherein the specific pattern frame is comprised of a plurality of patterns with different shapes from one another.

21. The optical touch device according to claim 16, wherein the display unit is a non-emissive display device and configured with a backlight source, the backlight source is configured to alternately emit visible light and invisible light, the emitted visible light is configured to illuminate the general image frame, while the emitted invisible light is configured to illuminate the specific pattern frame.

22. An optical touch method comprising:
displaying at least a general image frame;
displaying a specific pattern frame alternately with the at least a general image frame;
scanning a part of the specific pattern frame, simultaneously with displaying the specific pattern frame, so as to obtain image data corresponding to the part of the specific pattern frame; and
translating the image data into a coordinate position.

23. The optical touch method according to claim 22, wherein the at least a general image frame is displayed with a first frame refresh rate, and the specific pattern frame is displayed with a second frame refresh rate.

24. The optical touch method according to claim 23, wherein the second frame refresh rate is lower than the first frame refresh rate.

25. The optical touch method according to claim 23, wherein the first frame refresh rate is an integer multiple of the second frame refresh rate.

26. The optical touch method according to claim 22, further comprising:
displaying and positioning a cursor according to the coordinate position.

27. The optical touch method according to claim 22, wherein the image data is translated into the coordinate position on the assist of a look up table.

28. The optical touch method according to claim 22, wherein the specific pattern frame is formed by arranging a plurality of patterns with different shapes from one another.

29. The optical touch method according to claim 28, wherein during scanning the part of the specific pattern frame, when the scanned area is located among multiple ones of the patterns with different shapes, using an interpolation algorithm to translate the image data into the coordinate position.

30. The optical touch method according to claim 22, further comprising:
illuminating the specific pattern frame with invisible light.
